(19) United States
(12) Patent Application Publication
(10) Pub. No.: US 2015/0215319 A1
(43) Pub. Date: Jul. 30, 2015

(54) AUTHENTICATION SEQUENCING BASED ON NORMALIZED LEVELS OF ASSURANCE OF IDENTITY SERVICES

(71) Applicant: Symantec Corporation, Mountain View, CA (US)

(72) Inventors: Robert Koeten, Menlo Park, CA (US); Jeff L. Lowe, Sunnyvale, CA (US)

(73) Assignee: Symantec Corporation, Mountain View, CA (US)

(21) Appl. No.: 14/168,802

(22) Filed: Jan. 30, 2014

(51) Int. Cl. H04L 29/06

(52) U.S. Cl. CPC H04L 63/10

(57) ABSTRACT

An authentication sequencing and normalization module may receive a first authentication associated with a user and assign a level of assurance value to the user based on the first authentication from a first identity service of a specific type. If the user is associated with a second authentication, based on a second identity service of an alternate type, then the level of assurance value assigned to the user may be incremented. Furthermore, access to an application by the user may be allowed if the incremented level of assurance value assigned to the user meets or exceeds a second level of assurance value of a policy assigned to the application. Different users may be authenticated in the authentication sequencing and normalization module by disparate identity services.

### TECHNICAL FIELD

The present disclosure relates to authentication, and more particularly, authentication sequencing based on normalized levels of assurance of identity services.

### BACKGROUND

Single sign-on (SSO) provides access control to multiple independent software or network systems. For example, with SSO access control, a user may log in at one time and gain access to the multiple but independent software or network systems without being prompted to continuously log in at subsequent times at each of the independent software or network systems. As such, the SSO access control may reduce the number of times that a user needs to log in to the independent software or network systems, may not require the user to remember multiple different username and password combinations, and may reduce the amount of time that the user may be required to re-enter passwords.

The SSO access control may manage multiple identity services that each provides a different type or source of an authentication mechanism or service. Furthermore, once a user has been authenticated, the user may be allowed access to the software or network applications. For example, a user may access an application if the user has been authenticated against a first identity service. Furthermore, the user may also be authenticated against a second identity service. The user may access another application based on the authentication against the first identity service and the second identity service.

Policies may be assigned to the software or network applications to define identity services that a user may be authenticated against before the user may be authorized or allowed access each of the software or network applications. For example, an administrator of a central authentication server or system that provides the SSO access control may define that a first software or network application requires an authentication against a first identity service and a second identity service and that a second software or network application requires an authentication against a third identity service.

Thus, the administrator may be required to identify specific identity services for each individual software or network application. Such individual identification of identity services assigned to each software or network application may be complex if the central authentication server or system providing the SSO access control manages many different identity services.

### BRIEF DESCRIPTION OF THE DRAWINGS

The present disclosure will be understood more fully from the detailed description given below and from the accompanying drawings of various implementations of the disclosure.

FIG. 1 illustrates an example system architecture in accordance with various implementations.

FIG. 2 is a block diagram of an example identity service broker in accordance with some embodiments of the present disclosure.

FIG. 3 is a block diagram of an example of an authentication sequencing module in accordance with some embodiments.

FIG. 4 is a flow diagram illustrating an example method to increment a level of assurance in accordance with some embodiments of the present disclosure.

FIG. 5 is an illustration of an example user interface displaying identity services and levels of assurance in accordance with some embodiments.

FIG. 6 is an example method to provide authorization to access an application based on a level of assurance value and a supplemental attribute associated with a user in accordance with some embodiments of the present disclosure.

FIG. 7 is a block diagram of an example computer system that may perform one or more of the operations described herein.

### SUMMARY

A first authentication associated with a user may be identified. A level of assurance value may be assigned to the user based on the first authentication. A determination if the user is associated with a second authentication may be made. If the user is associated with the second authentication, then the level of assurance value assigned to the user may be incremented. Access to an application by the user may be allowed if the incremented level of assurance value assigned to the user meets or exceeds a second level of assurance value of a policy assigned to the application.

In some embodiments, a supplemental attribute associated with the user may be received from an identity service providing the first authentication or the second authentication and the second level of assurance value of the policy may be based on the supplemental attribute.

In some embodiments, the second level of assurance value of the policy may be based on the supplemental attribute such that if the supplemental attribute matches a condition of the policy then the second level of assurance value may be higher than if the supplemental attribute does not match the condition of the policy.

In some embodiments, the first authentication may be against a first identity service and the second authentication may be against a second identity service and the first identity service may be assigned the level of assurance value and the second identity service may be assigned a third level of assurance value. The incrementing of the level of assurance value assigned to the user may be by an amount equal to the third level of assurance value assigned to the second identity service.

In some embodiments, a second user may be authenticated against a third identity service and a fourth identity service that are different than the first and second identity services. The second user may be assigned a fourth level of assurance value based on level of assurance values assigned to the third and fourth identity services. Furthermore, access to the application may allowed if the fourth level of assurance value assigned to the second user meets or exceeds the second level of assurance value of the policy assigned to the application.

In some embodiments, a request from the user to access the application may be identified and it may be determined that the level of assurance value assigned to the user based on the first authentication does not meet or exceed the second level of assurance value of the policy assigned to the application. The second authentication may be assigned a third level of assurance value. Furthermore, determining if the user is associated with the second authentication and the incrementing of the level of assurance value assigned to the user may be performed in response to the determining that the level of assurance value assigned to the user based on the first authentication does not meet or exceed the second level of assurance value of the policy assigned to the application. The incrementing of the level of assurance value assigned to the user may be by an amount equal to the third level of assurance value.

In some embodiments, the first authentication may be a primary authentication and the second authentication may be a secondary authentication. The first authentication may be a first stage of a two factor authentication and the secondary authentication may be a second stage of the same two factor authentication.

### DETAILED DESCRIPTION

Described herein are a method and apparatus for authentication sequencing based on normalized levels of assurance of identity services. Authentication may refer to verification that an entity or a user is who the entity or user claims to be by using a type of source of an authentication mechanism. Authorization may refer to specifying access rights to resources (e.g., applications) for authenticated users. For example, a user may log in to a centralized authentication server or system that provides a single sign-on access control mechanism to multiple independent software or network systems by utilizing multiple types or sources of authentication mechanisms. The types or sources of authentication mechanisms may also be referred to as identity services. Accordingly, the centralized authentication server may be referred to as an identity service broker as it may manage multiple identity services.

Once a user has logged in to the identity service broker (e.g., through the SSO access control), the user may also be authenticated through or against identity services that are managed by the identity service broker. In some embodiments, the identity services may be categorized or grouped into a type or role of an identity service. For example, the identity services may be categorized as, but not limited to, a primary authentication service, a secondary authentication service, and a supplemental attribute service. Furthermore, in some embodiments, a single identity service may be categorized as providing two types of services. For example, a single identity service may provide a primary authentication service and a supplemental attribute service or any other combination of the services included herein.

Furthermore, each of the categories for the identity services may be associated with a level of assurance (LOA). In some embodiments, a level of assurance may correspond to a level of certainty that a credential representing an entity (e.g., a user) may be trusted to belong to the entity. For example, the level of assurance may indicate a level of certainty that the credential being presented by a user seeking authentication was actually issued to the user and not another user. Thus, the level of assurance may indicate a level of trust for a user who has been successfully authenticated against at least one identity service.

Accordingly, a level of assurance may be assigned to each of the identity services that are managed by the identity service broker. For example, a level of assurance at a value of 1 may be assigned to a first identity service and a level of assurance value of 2 may be assigned to a second identity service. When a user logs in to the identity service broker through the SSO access control, the user may be successfully authenticated by the first identity service and the second identity service. The identity service broker may increment a level of assurance value associated with the user to include the level of assurance values for the successful authentication against or provided by the first identity service and the second identity service. For example, the user may be associated with a level of assurance value of 3.

In some embodiments, the identity service broker may also provide access control (e.g., authorization) to software or network applications. For example, an administrator of the identity service broker may specify a policy to be assigned to each of the software or network applications that must be met in order for a user to access the software or network applications. In some embodiments, the identity service broker described herein may assign a level of assurance value for each policy and the policy may subsequently be assigned to the software or network applications. For example, a user may be authorized to access one of the software or network applications if the level of assurance value of the identity services that have successfully authenticated the user meets or exceeds a level of assurance value of the policy assigned to the software or network application. Furthermore, in some embodiments, the policy assigned to the software or network application may also define supplemental attributes of a user that are also provided by the identity services.

As such, the identity service broker may provide authentication sequencing of multiple identity services for a user. For example, the authentication sequencing may involve authenticating a user against a first identity service and then authenticating the user against a second identity service that may be linked to the first identity service. Furthermore, since the identity service broker may assign level of assurance values to policies, individual assigning of identity services to policies may no longer be necessary, resulting in a less complex and time consuming administration of the identity service broker and the corresponding identity services and policies.

Implementations of the present disclosure may include an authentication sequencing module, which is described in further detail below, to identify identity services associated with a user, incrementing a level of assurance value associated with a user based on the identity services, and authorizing access to applications based on the incremented level of assurance value associated with the user meeting or exceeding a level of assurance value associated with a policy. The features of the authentication sequencing module, which are described in further detail below, may include a receiver sub-module, a level of assurance assigner sub-module, an authentication determination sub-module, an incrementer sub-module, an authorization sub-module, and an attributes data sub-module.

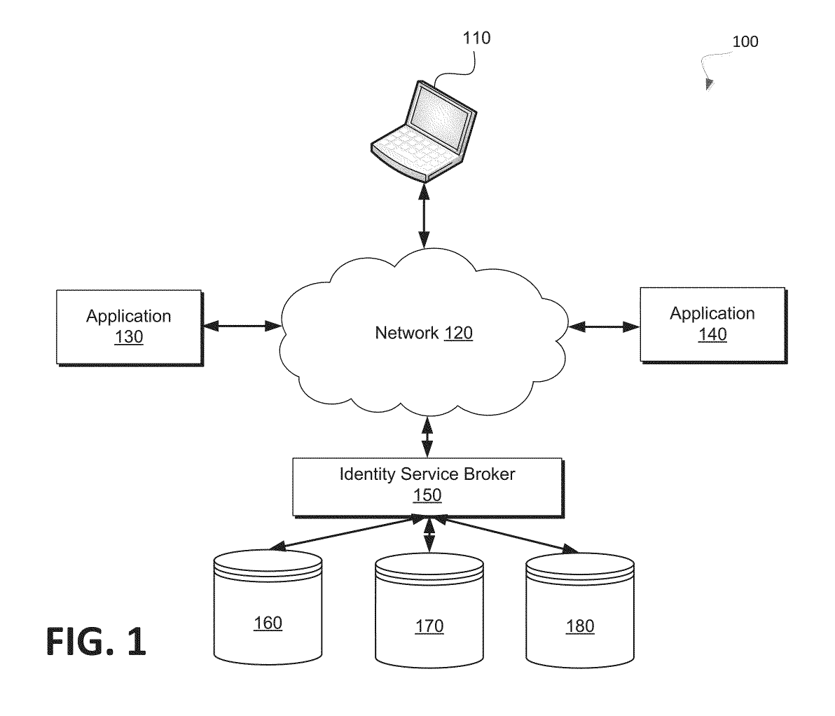

FIG. 1 illustrates an example system architecture 100 for various implementations. The system architecture 100 may include one or more computing devices 110, an identity service broker 150, and network applications 130 and 140 coupled to each other via a network 120. The network 120 may be a public network, a private network, a wireless network, a cellular network, or a combination thereof.

An identity service broker 150 may be a central authentication server that provides authentication sequencing and authorization access for a client of a computing device 110 to applications 130 and 140 that are hosted or provided by independent and separate network or software systems. A computing device 110 may be a desktop computer, laptop computer, or a portable computing device such as, but not limited to, mobile telephones, personal digital assistants (PDAs), portable media players, netbooks, tablet computers, portable gaming consoles, portable televisions, electronic book readers, and the like. As shown, one or more users may use the computing devices 110 to authenticate with an identity service broker 150 and receive authorization to access the applications 130 and 140. The identity service broker 150 may be considered a cloud computing based authentication system as it provides authentication and/or authorization services over the network 120 for remote servers that may host and/or execute applications 130 and 140.

The identity service broker 150 may authenticate a user based on one or more identity services 160, 170, and 180. For example, the identity service broker 150 may manage different types or sources of authentication mechanisms or information that are provided by the identity services 160, 170, and 180. Examples of authentication mechanisms may include, but are not limited to, a primary authentication, a secondary authentication, and supplemental attributes information. Primary authentication may refer to an authentication based on a user providing a username and password, a certificate, token, or other methods to uniquely and unambiguously identify a user. For example, a user may enter a username and password and the username and password may be matched against an authentication mechanism such as an active directory (AD) that may contain a repository of valid combinations of usernames and passwords. In some embodiments, a secondary authentication may refer to an authentication mechanism that must be provided in addition to the primary authentication. For example, a primary authentication may correspond to a username and password and the secondary authentication may correspond to a security token, digital certificates such as a Public Key Infrastructure (PKI) certificate, etc. The combination of the primary authentication with the secondary authentication may be referred to as a two factor or multi-factor authentication as two different authentication mechanisms or information are required for a user to be successfully authenticated. Furthermore, the supplemental attributes information may refer to user attributes of an authenticated user. In some embodiments, the user attributes of a user may be stored in a separate authentication source (i.e., identity service) or may also be associated or included with an identity service that provides either the primary authentication or the secondary authentication.

As shown in FIG. 1, the identity service broker 150 may manage the identity services 160, 170, and 180. Each of the identity services 160, 170, and 180 may provide a different authentication mechanism or information. For example, the identity service 160 may be an Active Directory or a Security Assertion Markup Language (SAML) source that provides a primary authentication based on a username and password. In some embodiments, the primary authentication may correspond to the single sign-on access control for the identity service broker 150. In the same or alternative embodiments, the primary authentication may also be based on a ticket (e.g., a Kerberos-based ticket) that is provided to a user in response to a first log-in by a user. Furthermore, the identity service 170 may provide a secondary authentication mechanism based on a PKI certificate, token, or any other such information. The identity service 180 may provide supplemental attributes that correspond to a user. In some embodiments, the identity services 160 and 170 may also provide supplemental attributes that correspond to the user.

The identity service broker 150 may be associated with and/or store policies associated with the applications 130 and 140. In some embodiments, the policies may include a level of assurance value and may be assigned to the applications 130 and 140. For example, a first policy including a level of assurance value of ‘2’ may be assigned to the application 130 and a second policy including a level of assurance value of ‘3’ may be assigned to the application 140. As the user of the computing device 110 authenticates with the identity service broker 150 against the identity services 160, 170, and 180, a level of assurance value may be calculated for the user based on which identity services 160, 170, and 180 the user has successfully authenticated against. For example, if the level of assurance value assigned to the user of the computing system 110 is ‘3’, then the user may access both application 130 and application 140. The identity service broker 150 may include functionality to define policies, assign the policies to applications, provide a single sign-on access control, and an authentication sequencing module to provide authentication sequencing based on normalized levels of assurance across the identity services 160, 170, and 180. Further details with regard to the identity service broker 150 and an authentication sequencing module are disclosed in further detail below.

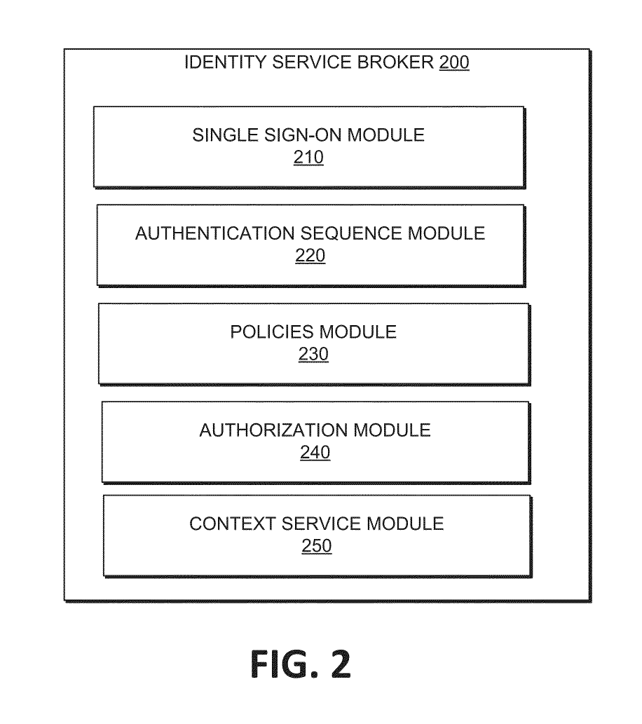

FIG. 2 is a block diagram of an identity service broker 200 in accordance with some embodiments. In general, the identity service broker 200 may correspond to the identity service broker 150 as shown in FIG. 1. The identity service broker 200 may include a single sign-on (SSO) module 210, an authentication sequencing module 220, a policies module 230, an authorization module 240, and a context service module 250. In alternative embodiments, the functionality of one or more of the modules may be combined or divided.

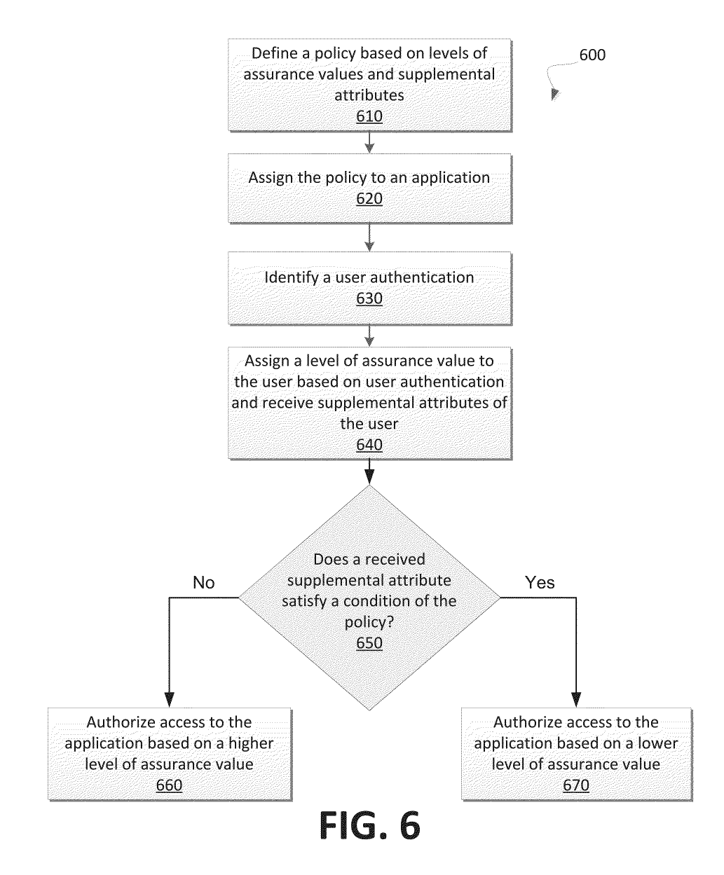

As shown in FIG. 2, the identity service broker 200 may include a single sign-on module 210. In some embodiments, the single sign-on module 210 may provide access control for a user to multiple networks or systems. For example, a user may provide a username and password to the single sign-on module 210 and be authenticated based on the username and password matching a valid username and password combination from an Active Directory (AD), SAML source, etc. or provide a Kerberos ticket. In some embodiments, the single-sign on may result in a primary authentication. Furthermore, the identity service broker 200 may include a policies module 230. In some embodiments, the policies module 230 may be used to define or assign a level of assurance value to a policy and to assign the policy to one or more applications. For example, a policy requiring a level of assurance value of ‘3’ may be assigned to an application and another policy requiring a level of assurance value of ‘2’ may be assigned to another application. As such, a policy may be a set of conditions (e.g., a level of assurance and/or attributes) associated with a user that the user must satisfy in order to be authorized and/or authenticated relative to an application. Furthermore, in some embodiments, the policies may also define a required supplemental attribute or session context attribute of a user and may vary a required level of assurance value based on supplemental attributes of users as is disclosed in further detail below with reference to FIG. 6. The identity services broker 200 may include an authorization module 240. In some embodiments, the authorization module 240 may allow or authorize access to one or more applications based on a user satisfying a policy assigned to the applications.

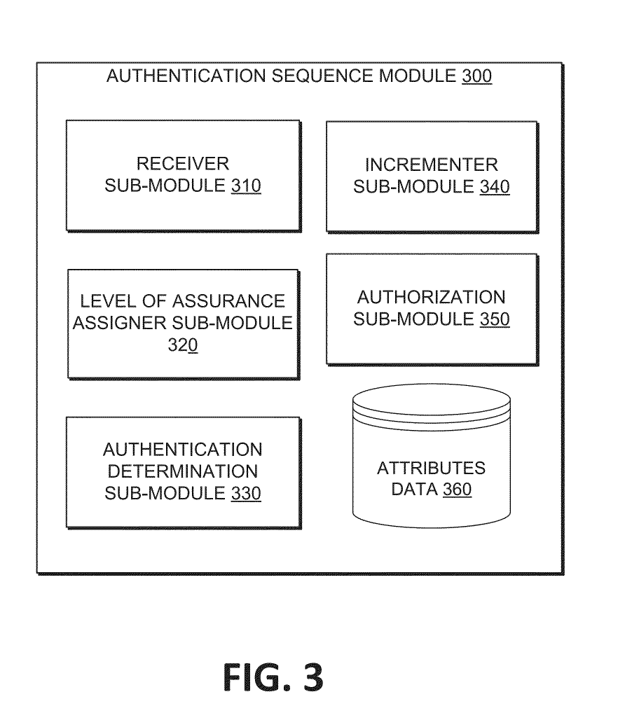

The identity services broker 200 may include an authentication sequencing module 220. In some embodiments, the authentication sequencing module 220 may calculate or generate a level of assurance value for a user who has accessed the identity service broker 200. For example, the authentication sequencing module 220 may increment a level of assurance value assigned to the user based on the types and/or sources of authentication information (e.g., identity services) that the user has successfully authenticated against (e.g., a secondary and/or a primary authentication) or is associated with (e.g., supplemental attributes source). Further details with regard to the authentication sequencing module 220 are disclosed in further detail with reference to FIG. 3.

As shown in FIG. 2, the identity service broker 200 may further include a context service module 250. In some embodiments, the context service module 250 may access a context of authenticated users. In the same or alternative embodiments, the context may include, but is not limited to, properties and attributes of users as well as the current level of assurance value assigned to the user. Furthermore, in some embodiments, the context service module 250 may access or generate session context information that includes information associated with a user session at the time that the user logged in to the SSO of the identity service broker 200. The session context information may include a username of a user who has logged in to the identity service broker, an authentication type of the identity service or identity services that the user has authenticated against, a level of assurance associated with the user, a time and date of the user session, a device type used by the user, a device reputation, device Internet Protocol (IP) address, etc.

As such, the identity services broker 200 may provide a single sign-on access control for a cloud-based system and/or other independent networks and systems that provide applications or services. The identity services broker 200 may be used to specify a level of assurance value and supplemental attributes for policies and assign the policies to the applications or services. Furthermore, a user may be assigned a level of assurance value based on the identity services associated with the user. The identity services broker 200 may authorize a user to access applications if the user's supplemental attributes and level of assurance value meets the conditions of the policy.

FIG. 3 is a block diagram of an authentication sequencing module 300 in accordance with some embodiments. In general, the authentication sequencing module 300 may correspond to the authentication sequencing module 320 in an identity services broker 150 or 200 as shown in FIGS. 1 and 2. The authentication sequencing module 300 may include a receiver sub-module 310, a level of assurance assigner sub-module 320, an authentication determination sub-module 330, an incrementer sub-module 340, an authorization sub-module 350, and an attributes sub-module 360. In alternative embodiments, the functionality of one or more of the sub-modules may be combined or divided.

As shown in FIG. 3, the authentication sequencing module 300 may include a receiver sub-module 310. In some embodiments, the receiver sub-module 310 may receive an indication of a first authentication of a user. For example, the receiver sub-module 310 may receive that a user has been successfully verified by an identity service that provides a primary authentication mechanism or source. In some embodiments, the receiver sub-module 310 may receive an identification that a user has provided a verified username and password or other such primary authentication information to a single sign-on access control service of an identity service broker. The authentication sequencing module 300 may further include a level of assurance (LOA) assigner sub-module 320. In some embodiments, the level of assurance assigner sub-module 320 may assign a level of assurance value to a user who has been successfully authenticated against a first identity service. For example, the level of assurance assigner sub-module 320 may assign a level of assurance value to a user to whom the receiver sub-module 310 received an indication of the first authentication of a user against an identity service that provides a primary authentication. For example, the user may be assigned a level of assurance value that is also assigned to the first identity service.

In some embodiments, a level of assurance may refer to an ability to determine with some level of certainty that an electronic credential representing a user can be trusted to actually belong to the user. As such, the level of assurance may be referred to as a type of identity assurance of a user. For example, users may be assigned a level of assurance value based on identity service authentication such that a high level of assurance value represents more trust than a comparatively low level of assurance value.

Returning to FIG. 3, the authentication sequence module 300 may include an authentication determination sub-module 330. In some embodiments, the authentication determination sub-module 330 may determine if a user has successfully authenticated against an additional identity service. For example, the authentication determination sub-module 330 may determine if a user who has successfully been authenticated against a first identity service (e.g., a primary authentication) has also been successfully authenticated against a second identity service (e.g., a secondary authentication). Furthermore, the incrementer sub-module 340 may increment or increase the level of assurance value that was assigned to the user by the level of assurance assigner sub-module 320 based on the user authenticating against the second identity service. In some embodiments, the incrementer sub-module 340 may increment or increase the level of assurance value assigned to a user based on any other additional identity service or authentication mechanism or source that is associated with the user. For example, the additional identity service may be assigned a level of assurance value and the level of assurance value assigned to the user may be increased by the level of assurance value assigned to the additional identity service.

In some embodiments, the authentication sequencing module 300 may include an attributes sub-module 360. The attributes sub-module 360 may be a persistent storage unit. In some embodiments, a persistent storage unit may be a local storage unit or a remote storage unit. Persistent storage units may be a magnetic storage unit, optical storage unit, solid state storage unit, electronic storage units (main memory), or similar storage unit. Persistent storage units may be a monolithic device or a distributed set of devices. A ‘set’, as used herein, refers to any positive whole number of items. In some embodiments, the attributes sub-module 360 may store and/or identify supplemental attributes associated with a user. The supplemental attributes may be stored within another identity service that also provides a primary authentication or a secondary authentication or may not provide any authentication.

The authentication sequence module 300 may further include an authorization sub-module 350. In some embodiments, the authorization sub-module 350 may authorize a user to access one or more applications based on a level of assurance that has been assigned to the user. In some embodiments, the authorization sub-module 350 may transmit the level of assurance value assigned to a user to the authorization module 240.

As such, the authentication sequence module 300 may assign a level of assurance value to a user based on the user authenticating against a primary authentication service (e.g., a first identity service). The user may be assigned a level of assurance value from the primary authentication service. In some embodiments, the user may also be linked to a secondary authentication service. For example, the primary authentication service used by the user may be linked to a secondary authentication service. If the user is linked with and successfully authenticates against the secondary authentication service (e.g., the second identity service), then the authentication sequence module 300 may increment or increase the level of assurance value that was assigned to the user. For example, the level of assurance value assigned to the user may be increased by a level of assurance value that has been assigned to the second identity service. Furthermore, the authentication sequence module 300 may retrieve and store supplemental attributes of the user that may be stored or associated with the primary and/or secondary authentication services or as a separate linked source of supplemental attributes of the user.

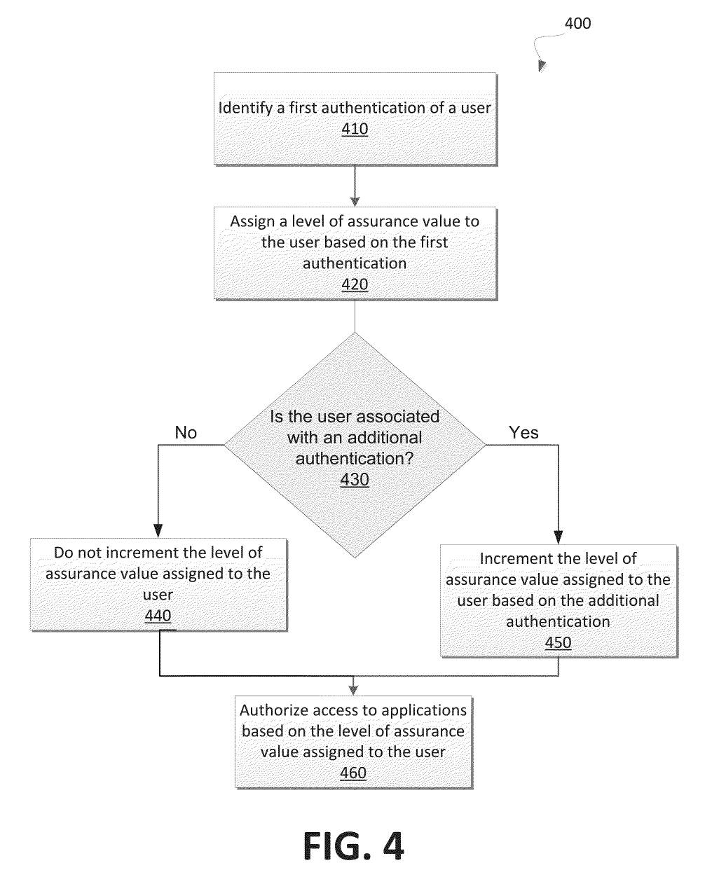

FIG. 4 is a flow diagram illustrating an example method 400 to increment a level of assurance. The method 400 may be performed by processing logic that may comprise hardware (e.g., a processing device, circuitry, dedicated logic, programmable logic, microcode, etc.), software (e.g., instructions run on a processing device), or a combination thereof. In some embodiments, the method 400 may be performed by an authentication sequence module 220 or 300 of FIGS. 2 and 3 in an identity service broker 150 or 200.

As shown in FIG. 4, the method 400 may begin by the processing logic identifying a first authentication of a user (block 410). For example, the processing logic may identify that a user has accessed a single sign-on access control of an identity service broker. In some embodiments, such a first authentication may be referred to as a primary authentication that is provided by a first identity service. The processing logic may further assign a level of assurance value to the user based on the first authentication (block 420). For example, the processing logic may assign a level of assurance value to the user based on the type of primary authentication or specific identity service that provides a primary authentication that the user has been successfully authenticated against. In some embodiments, the processing logic may assign a level of assurance value of such an identity service as the level of assurance value of the user.

The processing logic may further determine if the user is associated with an additional authentication (block 430). For example, the processing logic may determine if the user is associated with a secondary authentication. In some embodiments, the secondary authentication may be a part of a two factor authentication. As such, the secondary authentication may be a separate authentication service or a separate identity service that provides another authentication that is different than the first authentication of the user. In some embodiments, the determination of the additional authentication may be referred to as a step-up authentication. The determination may be made in response to a user attempting to access an application that is associated with a policy that has a level of assurance value higher than a current level of assurance value assigned to the user from the primary authentication service or first identity service. For example, a user may be associated with a primary authentication against a first identity service that is assigned a level of assurance value of 2. The user may also be assigned the level of assurance value of 2. The user may attempt to access an application that has been assigned a policy with a level of assurance value of 3. Since the user's current level of assurance value assigned from the first identity service is lower than the level of assurance value of the policy assigned to the application, a determination may be made as to whether the user is associated with a secondary authentication against a second identity service.

Returning to FIG. 4, if the user is not associated with an additional authentication (e.g., the user is not associated with a secondary authentication provided by the second identity service), then the processing logic may not increment the level of assurance value that has been assigned to the user (block 440). However, if the user is associated with an additional authentication (e.g., the user is associated with a secondary authentication provided by the second identity service), then the processing logic may increment the level of assurance value assigned to the user (e.g., from the first identity service) based on the additional authentication (block 450). For example, the processing logic may increment the level of assurance value that has been assigned to the user by an amount based on a level of assurance value assigned to the second identity service that provides the secondary authentication. As such, the incrementing of the level of assurance value may vary based on the identity service that provides the secondary authentication. For example, if a user is associated with a second identity service that provides a first secondary authentication and the second identity service is assigned a level of assurance value of 2, then the processing logic may increment the level of assurance value assigned to the user by a value of 2. However, if the user is not associated with the second identity service and is instead associated with another identity service that provides another secondary authentication and is assigned a level of assurance value of 1, then the processing logic may increment the level of assurance value assigned to the user by a value of 1.

Returning to FIG. 4, the processing logic may further authorize access to applications based on the level of assurance value associated with the user (block 460). For example, if the user was not associated with any additional authentication, then the user may be authorized to access applications based on the level of assurance value that was assigned to the user based on the first authentication. However, if the user is associated with the additional authentication, then the user may be authorized to access applications based on the level of assurance value that was incremented (e.g., the level of assurance value of the first authentication of the first identity service added to the level of assurance value of the second authentication of the second identity service).

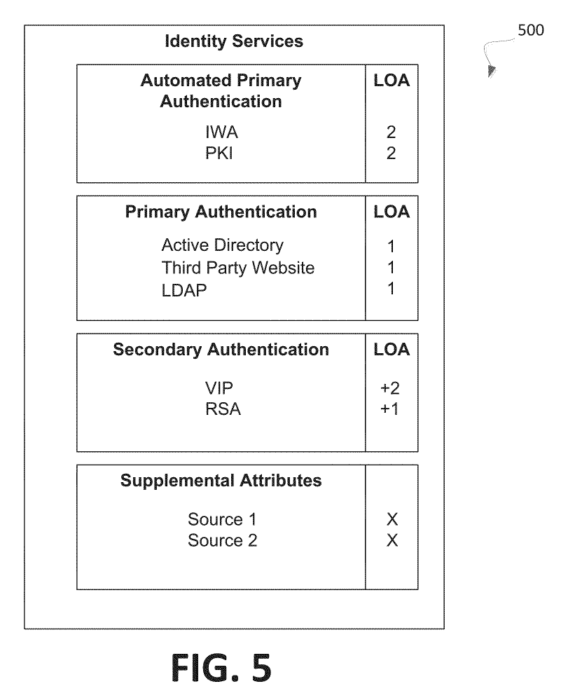

FIG. 5 is an illustration of an example user interface 500 displaying identity services and levels of assurances. In general, the user interface 500 may illustrate various identity services managed by an identity services broker and corresponding level of assurance values for the identity services. The user interface 500 may provide an overview of identity services 160, 170, and 180 that are administered by an identity services broker 150 or 200 of FIGS. 1 and 2.

As shown in FIG. 5, the user interface 500 may display multiple types of identity services. For example, identity services may be organized based on automated primary authentication, primary authentication, secondary authentication, and supplemental attributes. In some embodiments, the automated primary authentication may include, but are not limited to, Integrated Windows Authentication (WA) identity services, Public Key Infrastructure (PKI) identity services, Kerberos identity services, etc. Automated primary authentication may refer to an authentication mechanism where a user may be authenticated and receive a token and when the user navigates to a portal (e.g., the signal sign-on access control of the identity services broker), the token may be transmitted to the portal without user intervention. As such, in the automated primary authentication, a username or password or any other authentication information may not be manually entered by a user. Furthermore, an identity service that provides a non-automated primary authentication may be based on, but is not limited to, Active Directory, a third party website credential (e.g., a username and password of another network), Lightweight Directory Access Protocol (LDAP), Security Assertion Markup Language (SAML), PKI certificates, etc. In some embodiments, an identity service that provides a secondary authentication may also include any of the types of identity services as previously described. Furthermore, the user interface 500 may display sources of supplemental attributes. In some embodiments, the supplemental attributes may be user information or data that is received in response to a user authenticating against an identity service. For example, the supplemental attributes may include user profile information. In some embodiments, the supplemental attributes may be a separate identity service or may be included in another identity service that provides primary authentication or secondary authentication.

Returning to FIG. 5, the user interface 500 may also display level of assurance values associated with the various identity services. For example, as shown, the automated primary authentication identity services based on ‘TWA’ and ‘PKI’ may each be associated with a level of assurance value of 2. As such, if a user authenticated against either such identity service, the user will be initially assigned a level of assurance value of 2. Furthermore, the non-automated primary authentication identity services based on Active Directory, a third party website credential, and LDAP may each be associated with a level of assurance value of 1. In alternative embodiments, the level of assurance values associated with different identity services that provide primary authentication may be associated with different level of assurance values. As shown, the user interface 500 may also display an incremented level of assurance value associated with the identity services that provide the secondary authentication. For example, the identity service based on a ‘VIP’ authentication may be associated with an incremented level of assurance value of 2 and the identity service based on an ‘RSA’ authentication may be associated with an incremented level of assurance value of 1.

As an example, a user may be successfully authenticated against the identity service based on IWA and thus be assigned a level of assurance value of 2. In some embodiments, the user may also be linked to an identity service that provides a secondary authentication. For example, the identity service based on IWA may also be linked to a secondary authentication. As an example, if the user is also successfully authenticated against the identity service based on ‘VIP,’ then the level of assurance value assigned to the user may be incremented by a value of 2 for a level of assurance value of 4 being assigned to the user.

In some embodiments, an identity service that only provides supplemental attributes may not increase or increment the level of assurance value assigned to a user. However, in alternative embodiments, such identity services that only provide supplemental attributes of a user may result in the incrementing of the level of assurance value assigned to a user.

As such, the present disclosure may enable the normalization of identity service types and the normalization of level of assurance values for disparate identity services. Such normalization may facilitate the authentication and authorization policy decisions made by an identity service broker. As an example, a first user may log in (e.g., through the SSO) of an identity service broker and an authentication handler of the identity service broker may determine the identity services that are applicable or available to the user. In some embodiments, a primary authentication against a first identity service may be selected from the available identity services for the user that provide a primary authentication. The first identity service may further be linked to a second identity service from among multiple secondary identity services. For example, the first identity service may be normalized or assigned as a primary authentication and the second identity service may be normalized or assigned as a secondary authentication. The first identity service and the second identity service may provide different authentication types or mechanisms. For example, the first identity service may provide an authentication mechanism based on a username and a password (or other such primary authentication information) and the second identity service may provide an authentication mechanism based on a certificate, token, one time password, etc. In some embodiments, the user may be assigned a first level of assurance value that corresponds to the first identity service. The user may attempt to access an application that is assigned a policy with a policy level of assurance value. If the first level of assurance value assigned to the user from the first identity service does not meet or exceed the policy level of assurance value, then a step up authentication may be performed in response to the user's current level of assurance value not meeting or exceeding the policy level of assurance value. For example, a secondary authentication of the user may be performed. As such, the second identity service may be identified as an available secondary authentication available for the user. The user may be authenticated by the secondary authentication provided by the second identity service. In some embodiments, the second identity service may be assigned a second level of assurance value. Furthermore, the level of assurance value assigned to the user may then be incremented by an amount equal to the second level of assurance value. Next, the user may be allowed to access the application if the user's incremented level of assurance value meets or exceeds the policy level of assurance value.

As discussed, the disclosure herein allows for the normalization of identity service types and level of assurance values for disparate identity service types. For example, a second user may log in to the identity service broker and a third identity service may be selected as an available primary authentication among multiple such identity services and a fourth identity service may be selected as an available secondary authentication among multiple such identity services that provide a secondary authentication for the second user. The second user may authenticate against a primary authentication of the third identity service and be assigned a level of assurance value that is assigned to the third identity service. Furthermore, the second user may attempt to access the same or another application that is assigned the policy level of assurance value. If the second user's currently assigned level of assurance value from the third identity service meets or exceeds the policy level of assurance value, then the second user may access the application. However, if the second user's current level of assurance value does not meet or exceed the policy level of assurance value, then an available secondary authentication available to the second user may be selected. For example, the second user may be authenticated against a secondary authentication provided by the fourth identity service. Upon a successful authentication, the level of assurance value assigned to the second user may be incremented based on a level of assurance value assigned to the fourth identity service. Subsequently, if the second user's currently incremented level of assurance value from the third and fourth identity services meets or exceeds the policy level of assurance value, then the second user may access the application.

As such, a level of assurance value may be assigned to any type of identity service that provides any type of authentication mechanism. Furthermore, identity services may be normalized under identity service types such as a primary or secondary authentication as described and/or as a supplemental attribute identity service. Sequencing for a step up authentication may then be provided based on the normalized identity services.

FIG. 6 is an example method 600 to provide authorization to access an application based on a level of assurance value and a supplemental attribute associated with a user. The method 600 may be performed by processing logic that may comprise hardware (e.g., a processing device, circuitry, dedicated logic, programmable logic, microcode, etc.), software (e.g., instructions run on a processing device), or a combination thereof. In some embodiments, the method 600 may be performed by an authentication sequence module 220 or 300 of FIGS. 2 and 3 or another component or module of the identity services broker.

As shown in FIG. 6, the method 600 may begin by the processing logic defining a policy based on level of assurance values and supplemental attributes (block 610). For example, the processing logic may generate a policy to include conditions based on one or more level of assurance values and/or supplemental attributes. For example, the policy may specify a first level of assurance value if a supplemental attribute matches a first condition and the policy may further specify a second level of assurance value if the supplemental attribute does not match the first condition and/or matches a second condition. The processing logic may further assign the policy to an application (block 620). In some embodiments, a single policy may be assigned to multiple applications. Furthermore, the processing logic may identify an authentication of a user (block 630). For example, the processing logic may identify that a user has been authenticated against an identity service that provides a primary authentication and the processing logic may further identify if the user has been authenticated against any additional identity services such as an identity service that provides a secondary authentication. In response to identifying the authentication of the user, the processing logic may assign a level of assurance value to the user based on the user authentication and may further receive supplemental attributes of the user (block 640). For example, a user may be assigned a level of assurance value based on a primary authentication and the level of assurance value may be subsequently incremented if the user is also authenticated against a secondary authentication.

Returning to FIG. 6, the processing logic may make a determination of whether the supplemental attributes of the user satisfy a condition of the policy (block 650). For example, the policy may define one or more conditions of one or more supplemental attributes. If the supplemental attribute of the user does not satisfy the condition of the policy, then the user may be authorized to access an application that the policy was assigned to based on a higher level of assurance value (block 660). However, if the supplemental attribute of the user does satisfy the condition of the policy, then the user may be authorized to access the policy that the policy was assigned to based on a comparatively lower level of assurance value (block 670).

As an example, a supplemental attribute associated with a user may include a location of the user. The policy may assign a different level of assurance value required of a user based on the location supplemental attribute of the user. For example, the policy may define that users with a location supplemental attribute of ‘Mountain View, Calif., USA’ must be associated with a level of assurance value of 2 to access a corresponding application and the policy may further define that users with a location supplemental attribute that does not match ‘Mountain View, Calif., USA’ must be associated with a level of assurance value of 3 to access the corresponding application. As such, a required level of assurance value may vary based on one or more supplemental attributes of a user.

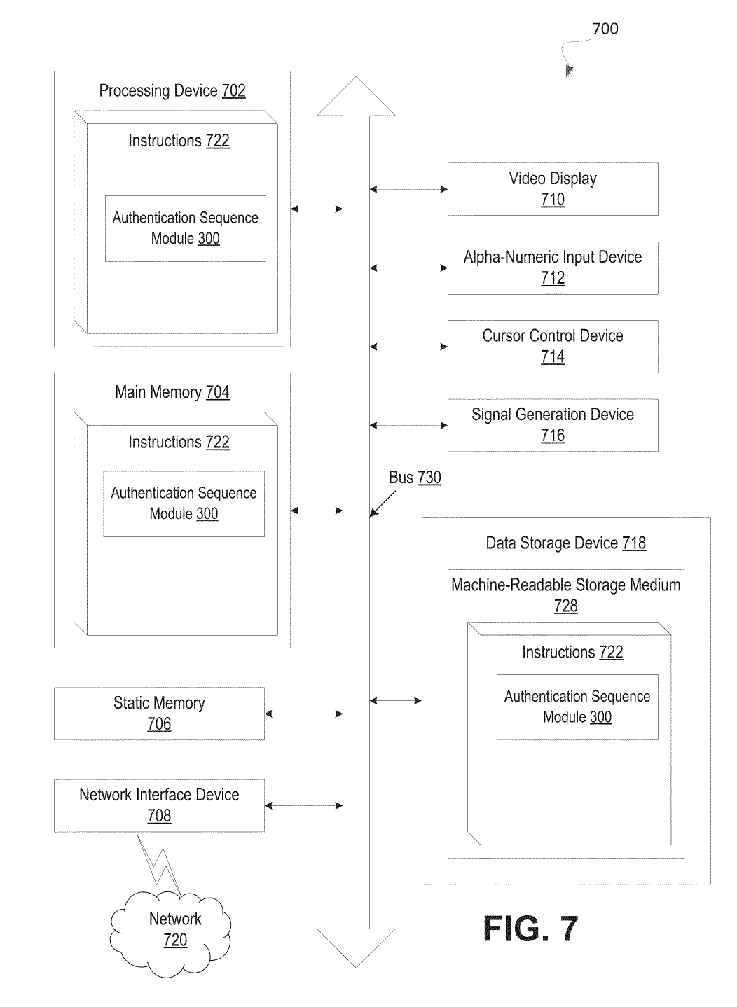

FIG. 7 illustrates an example machine of a computer system 700 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or DRAM (RDRAM), etc.), a static memory 706 (e.g., flash memory, static random access memory (SRAM), etc.), and a data storage device 718, which communicate with each other via a bus 730.

Processing device 702 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. The processing device 702 is configured to execute instructions 722 for performing the operations and steps discussed herein.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a machine-readable storage medium 728 (also known as a computer-readable medium) on which is stored one or more sets of instructions or software 722 embodying any one or more of the methodologies or functions described herein. The instructions 722 may also reside, completely or at least partially, within the main memory 704 and/or within the processing device 702 during execution thereof by the computer system 700, the main memory 704 and the processing device 702 also constituting machine-readable storage media.

In one implementation, the instructions 722 include instructions for an authentication sequence module (e.g., authentication sequence module 220 of FIG. 2 or authentication sequence module 300 of FIG. 3) and/or a software library containing methods that call modules or sub-modules in an authentication sequence module. While the machine-readable storage medium 728 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A method comprising:
identifying a first authentication associated with a user;
assigning a level of assurance value to the user based on the first authentication;
determining if the user is associated with a second authentication;
incrementing, if the user is associated with the second authentication, the level of assurance value assigned to the user; and
allowing, by a processing device, access to an application by the user if the incremented level of assurance value assigned to the user meets or exceeds a second level of assurance value of a policy assigned to the application.

2. The method of claim 1, further comprising:
receiving a supplemental attribute associated with the user from an identity service providing the first authentication or the second authentication, wherein the second level of assurance value of the policy is based on the supplemental attribute.

3. The method of claim 2, wherein the second level of assurance value of the policy is based on the supplemental attribute such that if the supplemental attribute matches a condition of the policy then the second level of assurance value is higher than if the supplemental attribute does not match the condition of the policy.

4. The method of claim 1, wherein the first authentication is against a first identity service and the second authentication is against a second identity service, and the first identity service is assigned the level of assurance value and the second identity service is assigned a third level of assurance value, and the incrementing of the level of assurance value assigned to the user is by an amount equal to the third level of assurance value assigned to the second identity service.

5. The method of claim 1, wherein a second user is authenticated against a third identity service and a fourth identity service that are different than the first and second identity services, the second user is assigned a fourth level of assurance value based on level of assurance values assigned to the third and fourth identity services, and access to the application is allowed if the fourth level of assurance value assigned to the second user meets or exceeds the second level of assurance value of the policy assigned to the application.

6. The method of claim 1, further comprising:
identifying a request from the user to access the application; and
determining that the level of assurance value assigned to the user based on the first authentication does not meet or exceed the second level of assurance value of the policy assigned to the application, wherein the second authentication is assigned a third level of assurance value, and wherein the determining if the user is associated with the second authentication and the incrementing of the level of assurance value assigned to the user are performed in response to the determining that the level of assurance value assigned to the user based on the first authentication does not meet or exceed the second level of assurance value of the policy assigned to the application, and the incrementing of the level of assurance value assigned to the user is by an amount equal to the third level of assurance value.

7. The method of claim 1, wherein first authentication is a primary authentication and the second authentication is a secondary authentication, the first authentication is a first part of an authentication sequence and the secondary authentication is a second part of the same authentication sequence.

8. A system comprising:
a memory; and
a processing device coupled with the memory to:
identify a first authentication associated with a user;
assign a level of assurance value to the user based on the first authentication;
determine if the user is associated with a second authentication;
increment, if the user is associated with the second authentication, the level of assurance value assigned to the user; and
allow access to an application by the user if the incremented level of assurance value assigned to the user meets or exceeds a second level of assurance value of a policy assigned to the application.

9. The system of claim 8, the processing device is further to:
receive a supplemental attribute associated with the user from an identity service providing the first authentication or the second authentication, wherein the second level of assurance value of the policy is based on the supplemental attribute.

10. The system of claim 9, wherein the second level of assurance value of the policy is based on the supplemental attribute such that if the supplemental attribute matches a condition of the policy then the second level of assurance value is higher than if the supplemental attribute does not match the condition of the policy.

11. The system of claim 8, wherein the first authentication is against a first identity service and the second authentication is against a second identity service, and the first identity service is assigned the level of assurance value and the second identity service is assigned a third level of assurance value, and the incrementing of the level of assurance value assigned to the user is by an amount equal to the third level of assurance value assigned to the second identity service.

12. The system of claim 11, wherein a second user is authenticated against a third identity service and a fourth identity service that are different than the first and second identity services, the second user is assigned a fourth level of assurance value based on level of assurance values assigned to the third and fourth identity services, and access to the application is allowed if the fourth level of assurance value assigned to the second user meets or exceeds the second level of assurance value of the policy assigned to the application.

13. The system of claim 8, wherein the processing device is further to:
identify a request from the user to access the application; and
determine that the level of assurance value assigned to the user based on the first authentication does not meet or exceed the second level of assurance value of the policy assigned to the application, wherein the second authentication is assigned a third level of assurance value, wherein the determining if the user is associated with the second authentication and the incrementing of the level of assurance value assigned to the user are performed in response to the determining that the level of assurance value assigned to the user based on the first authentication does not meet or exceed the second level of assurance value of the policy assigned to the application, and the incrementing of the level of assurance value assigned to the user is by an amount equal to the third level of assurance value.

14. The system of claim 8, wherein first authentication is a primary authentication and the second authentication is a secondary authentication, the first authentication is a first part of an authentication sequence and the secondary authentication is a second part of the same authentication sequence.

15. A non-transitory computer readable storage medium including instructions that, when executed by a processing device, cause the processing device to perform operations comprising:
identifying a first authentication associated with a user;
assigning a level of assurance value to the user based on the first authentication;
determining if the user is associated with a second authentication;
incrementing, if the user is associated with the second authentication, the level of assurance value assigned to the user; and
allowing access to an application by the user if the incremented level of assurance value assigned to the user meets or exceeds a second level of assurance value of a policy assigned to the application.

16. The non-transitory computer readable storage medium of claim 15, the operations further comprising:
receiving a supplemental attribute associated with the user from an identity service providing the first authentication or the second authentication, wherein the second level of assurance value of the policy is based on the supplemental attribute.

17. The non-transitory computer readable storage medium of claim 16, wherein the second level of assurance value of the policy is based on the supplemental attribute such that if the supplemental attribute matches a condition of the policy then the second level of assurance value is higher than if the supplemental attribute does not match the condition of the policy.

18. The non-transitory computer readable storage medium of claim 15, wherein the first authentication is against a first identity service and the second authentication is against a second identity service, and the first identity service is assigned the level of assurance value and the second identity service is assigned a third level of assurance value, and the incrementing of the level of assurance value assigned to the user is by an amount equal to the third level of assurance value assigned to the second identity service.

19. The non-transitory computer readable storage medium of claim 18, wherein a second user is authenticated against a third identity service and a fourth identity service that are different than the first and second identity services, the second user is assigned a fourth level of assurance value based on level of assurance values assigned to the third and fourth identity services, and access to the application is allowed if the fourth level of assurance value assigned to the second user meets or exceeds the second level of assurance value of the policy assigned to the application.

20. The non-transitory computer readable storage medium of claim 15, the operations further comprising:
identifying a request from the user to access the application; and
determining that the level of assurance value assigned to the user based on the first authentication does not meet or exceed the second level of assurance value of the policy assigned to the application, wherein the second authentication is assigned a third level of assurance value, and wherein the determining if the user is associated with the second authentication and the incrementing of the level of assurance value assigned to the user are performed in response to the determining that the level of assurance value assigned to the user based on the first authentication does not meet or exceed the second level of assurance value of the policy assigned to the application, and the incrementing of the level of assurance value assigned to the user is by an amount equal to the third level of assurance value.
